(19) United States
(12) Patent Application Publication
(10) Pub. No.: US 2012/0067356 A1
(43) Pub. Date: Mar. 22, 2012

(54) Dental Protection Device and Method

(76) Inventor: Jeffrey J. Supple, Albuquerque, NM (US)

(21) Appl. No.: 13/239,209

(22) Filed: Sep. 21, 2011

Related U.S. Application Data
(60) Provisional application No. 61/385,088, filed on Sep. 21, 2010.

(51) Int. Cl. A61C 5/14

(52) U.S. Cl. 128/861

(57) ABSTRACT

An apparatus and method for protecting teeth. The apparatus preferably is sold as a kit preferably comprises a generic flexible tray, a securing element such as adhesive, and a quick setting dental impression material. The apparatus preferably enables the rapid and simple taking of dental impressions. The apparatus preferably can rapidly be assembled and used by someone who is not a dental professional and is thus particularly suitable for use by hospital personnel prior to a surgery. The apparatus can protect the patient's teeth and surgical instruments which are inserted into the mouth during surgery.

### CROSS-REFERENCE TO RELATED APPLICATIONS

This application claims priority to and the benefit of filing of U.S. Provisional Patent Application Ser. No. 61/385,088, entitled “DENTAL PROTECTION DEVICE AND METHOD”, filed on Sep. 21, 2010, which is incorporated herein by reference.

### BACKGROUND OF THE INVENTION

1. Field of the Invention (Technical Field)

The present invention relates to methods and apparatuses for protecting teeth and medical instruments, particularly for providing rapidly formed, temporary protection during endoscopy or other through-the-mouth medical procedures.

2. Background Art

Note that the following discussion may refer to a number of publications and references. Discussion of such publications herein is given for more complete background of the scientific principles and is not to be construed as an admission that such publications are prior art for patentability determination purposes.

During endoscopy, laryngoscopy, tonsillectomy, intubation, or other through-the-mouth medical procedures, damage can occur to either or both of a patient's teeth and the endoscope, endotracheal tube, or other medical instrument. This damage can be caused by dragging the instrument across the teeth or otherwise contacting the teeth with the instrument, or by the sudden reflexive clenching of the jaw of the patient, resulting in the patient biting down on the instrument. The teeth (and the instrument) can be scratched, chipped, or broken. Although custom dental trays exist, they require either a visit to a dentist to make impressions or boiling water. None are practical for use in a pre-surgical environment.

### SUMMARY OF THE INVENTION

### Disclosure of the Invention

An embodiment of the present invention is an apparatus for protecting teeth, the apparatus comprising a non-rigid tray, a securing element; and an impression material secured to the non-rigid tray by the securing element. The impression material preferably retains a preferably inexact impression of teeth; that is, the impression is preferably less accurate than an impression useful for the production of crowns or dentures. The tray preferably does not comprise an impression of teeth. The securing element preferably comprises an element selected from the group consisting of liquid adhesive, an adhesive layer or strip, and double-sided tape, or optionally comprises an element selected from the group consisting of a hook and loop strip, holes in the tray, a tray retention lip, and a self-retentive strip. The impression material preferably comprises a bite registration material. The impression material preferably cures in less than approximately two minutes, more preferably in less than approximately ninety seconds, and even more preferably in between approximately sixty seconds and approximately ninety seconds. The impression material preferably comprises an antibacterial component or treatment.

An embodiment of the present invention is a kit for producing a tooth protection apparatus, the kit comprising one or more impression trays and impression material or precursors that form impression material when mixed. The kit preferably comprises impression trays in different sizes. The one or more impression trays are preferably non-rigid. Each tray preferably comprises a securing element, or alternatively the kit comprises a supply of securing element for application on the one or more impression trays. The supply of securing element is preferably divided into premeasured amounts, each premeasured amount corresponding to a size of an impression tray. When impression material is included in the kit, the impression material is preferably divided into premeasured amounts, each premeasured amount corresponding to a size of an impression tray. When precursors that form impression material when mixed is included in the kit, the kit preferably comprises an applicator for mixing the precursors and applying the resultant impression material to an impression tray. The impression material preferably comprises a bite registration material. The impression material preferably cures in less than approximately two minutes, more preferably in less than approximately ninety seconds, and even more preferably in between approximately sixty seconds and approximately ninety seconds. The impression material preferably comprises an antibacterial component or treatment.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 shows an embodiment of a tray of the present invention.

FIG. 2 shows adhesive inside the tray of FIG. 1.

FIG. 3 shows bite registration material being disposed within the tray of FIG. 2.

FIG. 4 shows an embodiment of the present invention after the bite registration material has set with an impression of a patient's teeth.

### DESCRIPTION OF THE PREFERRED EMBODIMENTS

### Best Modes for Carrying Out the Invention

Embodiments of the present invention are preferably related to a temporary, disposable, inexpensive dental protection device that can rapidly and easily be custom fit to a patient by a nurse or doctor prior to a medical or surgical procedure. It is preferable, although not required, that two devices of the present invention are applied to each of the top and bottom teeth of the patient, and that the device and its component materials be suitable for remaining in the patient's mouth for the length of the procedure.

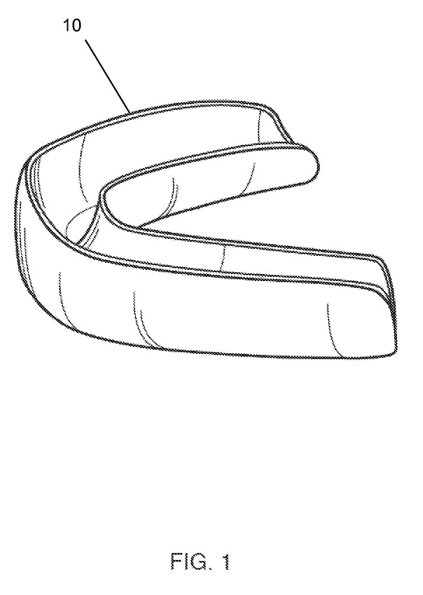

FIG. 1 shows an embodiment of an impression tray of the present invention. Tray 10 may comprise any material, but preferably comprises a thermo-forming material such as ethylene vinyl copolymer. The material is preferably vacuum-formed to make a generic, flexible molded tray that will fit over the upper or lower teeth of any patient. Unlike current uses of such a material such as mouthguards, the tray preferably does not have an impression of the patient's teeth. Different sizes of trays, for example small, medium, and large, are preferably stocked so the proper size may easily be chosen for use with a particular patient. Tray 10 preferably comprises a material that is thin and non-rigid; that is, flexible, somewhat flexible or semi-rigid for the comfort of the patient. The material may alternatively be rigid.

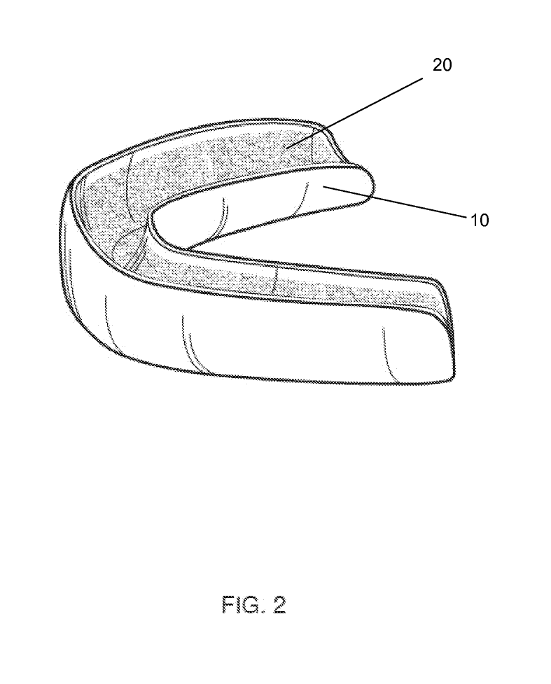

As shown in FIG. 2, adhesive 20 is preferably applied inside tray 10. Any adhesive may be used, as long as it is compatible with the tray material and the impression material. Adhesive 20 optionally comprises a liquid, for example VPS Tray Adhesive by 3M™, which is brushed on tray 10 prior to fitting. The tray may alternatively comprise any means for fastening, such as an adhesive layer with a protective pull-off strip or a double sided tape (or the like) which may be applied to tray 10 prior to fitting or pre-applied to tray 10 by the manufacturer.

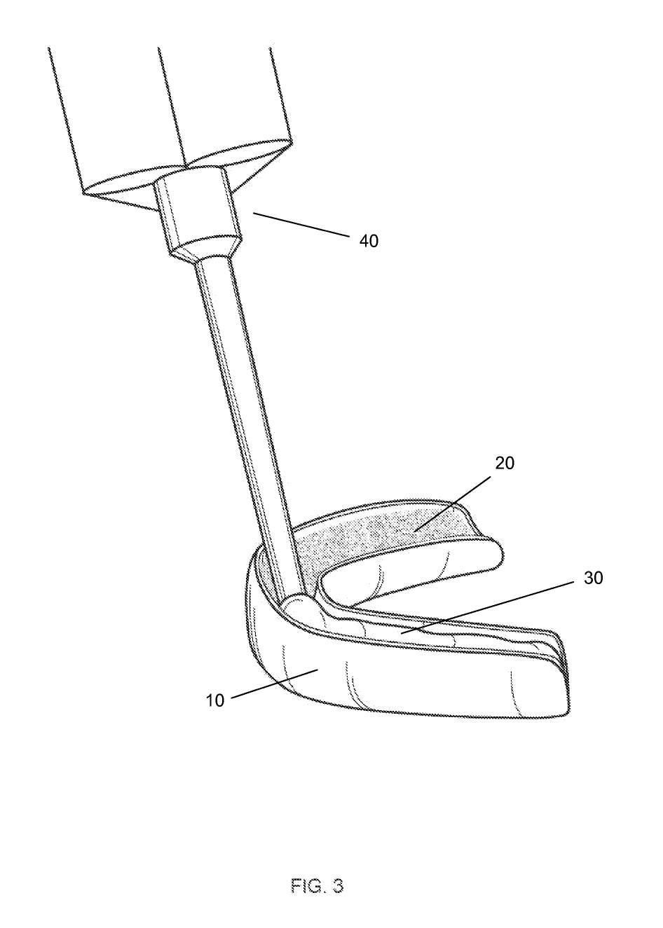

After the adhesive is applied (or exposed), an impression material 30, which preferably comprises a cream, paste or mousse, is preferably applied to tray 10 so that it is in contact with adhesive 20, as shown in FIG. 3. Any impression material that sets, cures, or otherwise hardens can be used, for example denture cream or an elastomeric material, although impression material 30 preferably comprises a bite registration material such as vinyl polysiloxane, for example Genie Bite ® by Sultan Healthcare. Similar bite registration materials are typically currently not used with a tray in the dental industry. In general, any means for capturing dental impressions may be employed. Impression material 30 preferably comprises two or more components and preferably does not start setting until it is mixed during application via applicator 40. Impression material 30 may optionally be made available in pre-packaged amounts corresponding to the generic sizes of tray 10. It is preferable that only a sufficient quantity of impression material to secure the device to, and form an impression of, the patient's teeth is used; a mess can result if tray 10 is overfilled.

In alternative embodiments of the present invention, the impression material may be retained in the tray by the configuration or texture of the tray or a component thereof. For example, the tray may comprise holes, a retention lip, and/or a self-retentive strip, such as a hook and loop strip as described in

U.S. Pat. No. 6,875,016. In general, any means for at least temporarily retaining the impression material in the tray may be used. As used throughout the specification and claims, the term “securing element” means an element to secure bite registration or impression material to a tray, including but not limited to liquid adhesive, an adhesive layer or strip, double-sided tape, a hook and loop strip, holes in the tray, a tray retention lip, a self-retentive strip and the like.

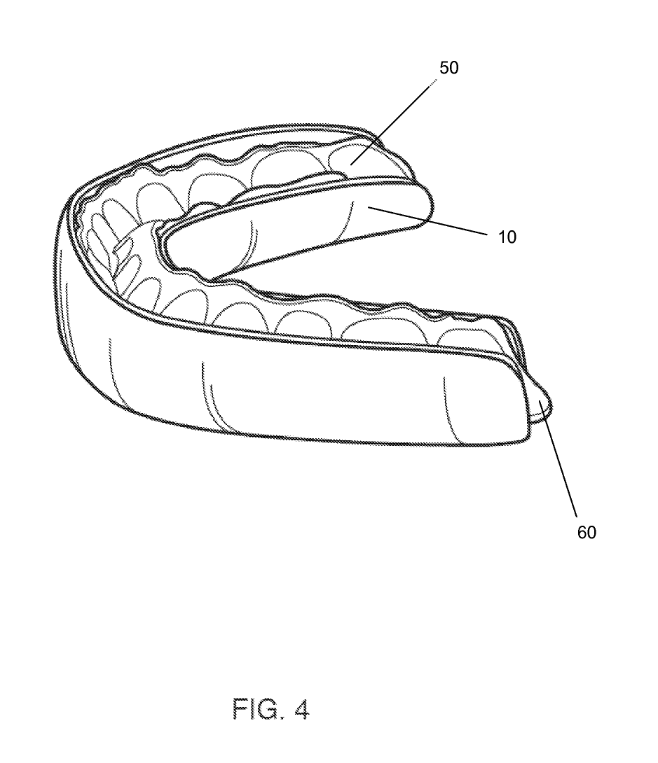

Once impression material 30 is added to tray 10, the device is fitted to the patient's teeth (upper or lower), and left until set. Impression material 30 preferably sets rapidly, preferably in less than two minutes, more preferably between one and two minutes, and even more preferably between one minute and ninety seconds, and adheres to tray 10 via adhesive 20 or other means such as those described above. FIG. 4 shows the device comprising set impression material 50 with the patient's dental impression. Excess set impression material, for example indicated at 60, may optionally be trimmed off.

The device of the present invention may be assembled and fit to a patient in just a few minutes by a nurse, doctor, or other medical personnel just prior to the medical procedure, or at any earlier time such as the night before. The personnel does not have to be a dental professional. Once the procedure is finished, the device may be suitably disposed of.

Unlike dental impressions used, for example, for crowns or dentures, the accuracy of the present invention is not critical for use during medical procedures such as those described herein; an exact, precision fit and/or use of a rigid, inflexible tray is not necessary. In addition, embodiments of the present invention are preferably easy to assemble and insert prior to the procedure, and easy to remove after the procedure. Thus embodiments of the present invention comprise a combination of a flexible tray and a quick-setting bite registration material.

An embodiment of the present invention is a kit for assembling a temporary dental protection device. The kit is preferably usable in a medical office or facility such as an emergency room or hospital. The kit preferably comprises a variety of sizes of generic trays. The trays may comprise means for retaining bite registration material, such as a textured strip or an adhesive strip. Alternatively the kit may comprise an adhesive. The kit also preferably comprises bite registration material. The uncured material may be loaded in an applicator, or may alternatively come in pre-sized packages.

Prior to many types of surgeries, such as knee or hip replacements, a patient is often directed to have their teeth cleaned to reduce the possibility of bacteria entering the bloodstream and possibly causing an infection that affects the new joint. An untreated dental condition or infection can result in bacteria lodging in the implanted artificial joint, which can adversely affect healing. For these types of procedures, alternate embodiments of the present invention comprise a device comprising one or more antibacterial materials or treatments. For example, the bite registration material used may comprise one or more antibacterial drugs or other components. Such devices may be used in addition to, or alternative to, a pre-surgical dental cleaning. Such devices are also useful for surgeries in trauma or other emergency situations in which there may be damage to the teeth or gums, or in which the status of the patient's dental health is unknown.

Although the invention has been described in detail with particular reference to the described embodiments, other embodiments can achieve the same results. Variations and modifications of the present invention will be obvious to those skilled in the art and it is intended to cover all such modifications and equivalents. The entire disclosures of all patents and publications cited above are hereby incorporated by reference.

What is claimed is:

1. An apparatus for protecting teeth, the apparatus comprising:
a non-rigid tray;
a securing element; and
an impression material secured to said non-rigid tray by said securing element.

2. The apparatus of claim 1 wherein said impression material retains an impression of teeth.

3. The apparatus of claim 2 wherein the impression is inexact.

4. The apparatus of claim 3 wherein said impression is less accurate than an impression useful for the production of crowns or dentures.

5. The apparatus of claim 1 wherein said tray does not comprise an impression of teeth.

6. The apparatus of claim 1 wherein said securing element comprises an element selected from the group consisting of liquid adhesive, an adhesive layer or strip, and double-sided tape

7. The apparatus of claim 1 wherein said securing element comprises an element selected from the group consisting of a hook and loop strip, holes in the tray, a tray retention lip, and a self-retentive strip.

8. The apparatus of claim 1 wherein said impression material comprises a bite registration material.

9. The apparatus of claim 1 wherein said impression material cures in less than approximately two minutes.

10. The apparatus of claim 9 wherein said impression material cures in less than approximately ninety seconds.

11. The apparatus of claim 10 wherein said impression material cures in between approximately sixty seconds and approximately ninety seconds.

12. The apparatus of claim 1 wherein said impression material comprises an antibacterial component or treatment.

13. A kit for producing a tooth protection apparatus, the kit comprising:
one or more impression trays; and
impression material or precursors that form impression material when mixed.

14. The kit of claim 13 comprising impression trays in different sizes.

15. The kit of claim 13 wherein said one or more impression trays are non-rigid.

16. The kit of claim 13 wherein each said tray comprises a securing element.

17. The kit of claim 13 further comprising a supply of securing element for application on said one or more impression trays.

18. The kit of claim 17 wherein said supply of securing element is divided into premeasured amounts, each premeasured amount corresponding to a size of an impression tray.

19. The kit of claim 13 wherein said impression material is divided into premeasured amounts, each premeasured amount corresponding to a size of an impression tray.

20. The kit of claim 13 further comprising an applicator for mixing said precursors and applying the resultant impression material to an impression tray.

21. The kit of claim 13 wherein said impression material comprises a bite registration material.

22. The kit of claim 13 wherein said impression material cures in less than approximately two minutes.

23. The apparatus of claim 22 wherein said impression material cures in less than approximately ninety seconds.

24. The apparatus of claim 23 wherein said impression material cures in between approximately sixty seconds and approximately ninety seconds.

25. The apparatus of claim 13 wherein said impression material comprises an antibacterial component or treatment.
